(19) United States
(12) Patent Application Publication
(10) Pub. No.: US 2024/0272388 A1
(43) Pub. Date: Aug. 15, 2024

(54) ARCHITECTURE AND METHOD FOR V GROOVE FIBER ATTACH FOR A PHOTONIC INTEGRATED CIRCUIT (PIC)

(71) Applicant: Intel Corporation, Santa Clara, CA (US)

(72) Inventors: Xiaoqian Li, Chandler, AZ (US); Omkar G. Karhade, Chandler, AZ (US); Nitin A. Deshpande, Chandler, AZ (US)

(73) Assignee: Intel Corporation, Santa Clara, CA (US)

(21) Appl. No.: 18/168,927

(22) Filed: Feb. 14, 2023

(51) Int. Cl. G02B 6/42

(52) U.S. Cl. CPC G02B 6/4278; G02B 6/4202; G02B 6/4243

(57) ABSTRACT

An architecture for v-groove fiber attach for a photonic integrated circuit (PIC). The architecture is characterized by a PIC with a thickness of less than 100 microns. A carrier layer is attached to the non-active surface of the PIC and v-grooves are etched into the active surface of the PIC wafer. The carrier layer functions as an etch stop during the etching of the v-grooves, thereby becoming a floor for the v-grooves and enabling the v-grooves to extend to a depth equal to the thickness of the PIC. The carrier layer can be a glass layer. The carrier layer can also be an electronic integrated circuit (EIC).

### BACKGROUND

The off-package input/output (I/O) bandwidth demand of high-performance packages has been steadily increasing, putting pressure on packaging and I/O technologies to keep up with the demand. Increased data rates reduce the electrical I/O reach (length of electrical printed circuit board (PCB) trace or cable). To meet these increased requirements, integrated optical circuits, such as photonic integrated circuits (PICs), may be co-packaged with the electronic components. Accordingly, architectures and methods for high-performance packages that effectively interface electrical and optical circuits are desirable.

### BRIEF DESCRIPTION OF THE DRAWINGS

FIG. 1 illustrates an example multi-die assembly that implements an architecture for v-groove fiber attach for a PIC, in accordance with various embodiments.

FIGS. 2-5 are simplified cross-sectional illustrations depicting various stages of development/manufacture of the architecture for v-groove fiber attach for a PIC, in accordance with various embodiments.

FIG. 6 illustrates example process steps for a method for manufacturing and implementing the architecture for v-groove fiber attach for a PIC, in accordance with various embodiments.

FIG. 7 is a top view of a wafer and dies that may be included in a microelectronic assembly, in accordance with any of the embodiments disclosed herein.

FIG. 8 s a simplified cross-sectional side view showing an implementation of an integrated circuit on a die that may be included in various embodiments, in accordance with any of the embodiments disclosed herein.

FIG. 9 is a cross-sectional side view of a microelectronic assembly that may include any of the embodiments disclosed herein.

FIG. 10 is a block diagram of an example electrical device that may include any of the embodiments disclosed herein.

### DETAILED DESCRIPTION

The off-package input/output (I/O) bandwidth demand and increased data rates of high-performance packages has been steadily increasing, putting pressure on packaging and I/O technologies to keep up with the demand. However, I/O energy efficiency improvement with high-performance packages based on electronic components has slowed. These technical problems have caused some concern that existing high performance packaging technologies exclusively based on electronic components are quickly approaching an I/O power wall.

To meet the increased bandwidth demand and I/O energy efficiency requirements of high-performance packages, integrated optical circuits may be co-packaged with electronic components. An example of an integrated optical circuit is a photonic integrated circuit (PIC). PICs implement one or more photonic functions and comprise one or more optical components, such as waveguides, lasers, electro-optical modulators, polarizers, photodetectors, and the like. PICs are often used in data communications (such as fiber-optic communication) and sensing applications. Examples of uses for PICs include wavelength division multiplexing (WDM), interferometers, wave modulators, optical transceivers, light detection and ranging (LiDAR) antennas, and the like.

A proposed solution co-packages a PIC with an electronic component. Optical fibers coupled to the PIC at a first terminus can carry I/O optical signals off-package at a second terminus. Between the first terminus and the second terminus, the optical fibers may lie in respective v-grooves on the PIC.

Available methodologies can create a v-groove depth of about 75 microns, which introduces a required thickness for a PIC wafer of not less than about 150 microns to avert the risk of cracking the PIC wafer. However, in some scenarios it is desirable to have a wafer thickness of less than about 85 microns; for example, applications implementing through-holes or through silicon vias (TSVs) in the PIC wafer require a wafer thickness of less than about 85 microns to achieve a necessary diameter-to-depth ratio for the TSVs. Therefore, a technical problem is presented when v-grooves are to be implemented on a PIC wafer that has to have a thickness of less than 150 microns.

Embodiments disclosed herein propose a technical solution to the above-described technical problems in the form of an architecture for v-groove fiber attach for a PIC. Proposed embodiments enable thinning the PIC wafer below the aforementioned 150 microns, to less than 100 microns, while concurrently enabling v-grooves in the PIC wafer. These concepts are developed in more detail below.

Example embodiments are hereinafter be described in conjunction with the following drawing figures, wherein like numerals denote like elements. Figures are not necessarily to scale but may be relied on for spatial orientation and relative positioning of features. As may be appreciated, certain terminology, such as “ceiling” and “floor”, as well as “upper,”, “uppermost”, “lower,” “above,” “below,” “bottom,” and “top” refer to directions based on viewing the Figures to which reference is made. Further, terms such as “front,” “back,” “rear,”, “side”, “vertical”, and “horizontal” may describe the orientation and/or location of portions of the component within a consistent but arbitrary frame of reference which is made clear by reference to the text and the associated Figures describing the component under discussion. Such terminology may include the words specifically mentioned above, derivatives thereof, and words of similar import.

As used herein, the term “adjacent” refers to layers or components that are in direct physical contact with each other, with no layers or components in between them. For example, a layer X that is adjacent to a layer Y refers to a layer that is in direct physical contact with layer Y. In contrast, as used herein, the phrase(s) “located on” (in the alternative, “located under,” “located above/over,” or “located next to,” in the context of a first layer or component located on a second layer or component) includes (i) configurations in which the first layer or component is directly physically attached to the second layer (i.e., adjacent), and (ii) component and configurations in which the first layer or component is attached (e.g. coupled) to the second layer or component via one or more intervening layers or components.

Terms or values modified by the word “substantially” include arrangements, orientations, spacings, or positions that vary plus or minus 20% from the meaning of the unmodified term or value. Terms or values modified by the word “about” include values inclusive of 10% less than the term or value to inclusive of 10% greater than the term or value.

As used herein, the term “electronic component” can refer to an active electronic circuit (e.g., processing unit, memory, storage device, FET) or a passive electronic circuit (e.g., resistor, inductor, capacitor).

As used herein, the term “integrated circuit component” can refer to an electronic component configured on a semiconducting material to perform a function. An integrated circuit (IC) component can comprise one or more of any computing system components described or referenced herein or any other computing system component, such as a processor unit (e.g., system-on-a-chip (SoC), processor core, graphics processor unit (GPU), accelerator, chipset processor), I/O controller, memory, or network interface controller, and can comprise one or more additional active or passive devices such as capacitors, decoupling capacitors, resistors, inductors, fuses, diodes, transformers, sensors, electrostatic discharge (ESD) devices, and memory devices.

A non-limiting example of an unpackaged integrated circuit component includes a single monolithic integrated circuit die (also shortened herein to “die”); the die may include solder bumps attached to contacts on the die. When present on the die, the solder bumps or other conductive contacts can enable the die to be directly attached to a printed circuit board (PCB) or other substrates.

A non-limiting example of a packaged integrated circuit component comprises one or more integrated circuit dies mounted on a package substrate with the integrated circuit dies and package substrate encapsulated in a casing material, such as a metal, plastic, glass, or ceramic. Often the casing includes an integrated heat spreader (IHS); the packaged integrated circuit component often has bumps, leads, or pins attached to the package substrate (either directly or by wires attaching the bumps, leads, or pins to the package substrate) for attaching the packaged integrated circuit component to a printed circuit board (or motherboard or base board) or another component.

The following detailed description is not intended to limit the application and use of the disclosed technologies. It may be evident that the novel embodiments can be practiced without every detail described herein. For the sake of brevity, well-known structures and devices may be shown in block diagram form to facilitate a description thereof.

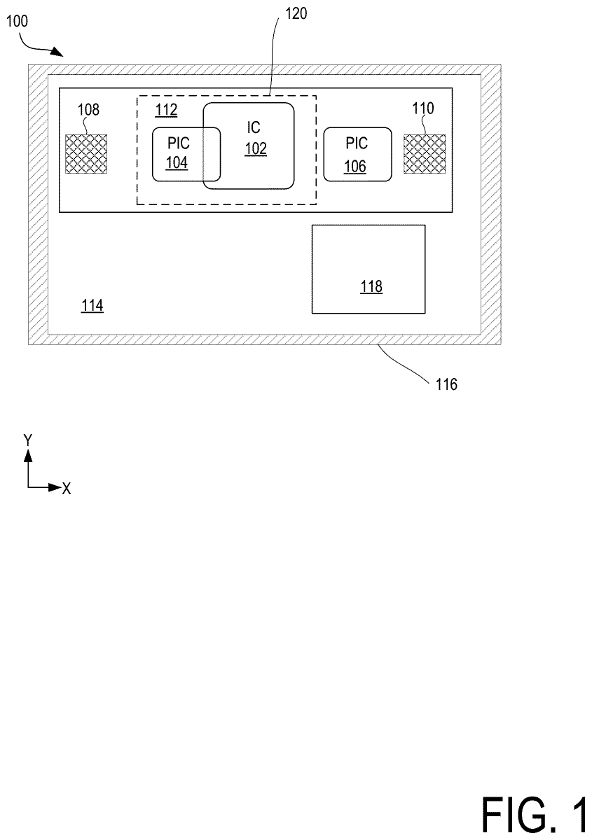

FIG. 1 provides an example multi-die assembly 100 that implements the architecture for v-groove fiber attach for a PIC. The multi-die assembly 100 comprises an electrical integrated circuit (EIC) die, alternately referred to as an integrated circuit (IC) die 102 a first photonic integrated circuit (PIC) die 104 and a second PIC die 106. Optional fiber array units (FAUs) may be added. Optical fibers described herein as originating on a PIC die may be operably connected externally to a fiber array unit. For example, in the non-limiting example, the PIC die 104 is operably connected to fiber array unit (FAU) 108 and the PIC die 106 is operably connected to FAU 110. As may be appreciated, this arrangement of die is just one example embodiment, in other multi-die assemblies, there may be more or less PIC die, more or less FAU components, more or less ICs, and the die may be arranged in any pattern (e.g., square (e.g., 2×2, 4×4, 6×6), rectangular (e.g., 2×4, 3×5, 4×7)). The die may be attached to a substrate 112. In various embodiments, the substrate 112 may comprise a printed circuit board, thin-film substrate, or another suitable substrate. In other embodiments, the substrate 112 may further be attached to a printed circuit board (PCB) 114; and in further embodiments, the multi-die assembly may include additional IC die, represented generally as die 118.

In various embodiments, the die in the multi-die assembly 100 can be overmolded with an encapsulant 116. The encapsulant 116 can comprise a molding compound, dielectric materials, metal, ceramic, plastic, or a combination thereof. Additionally, a thermal management solution (not shown) comprising a cooling component such as a vapor chamber, heat pipe, heat sink, or liquid-cooled cold plate may be attached to a multi-die assembly 100. As part of a thermal management solution, a thermal conduction layer interface material (TIM) may be located over the die 102. The TIM can be any suitable material, such as a silver particle-filled thermal compound, thermal grease, phase change materials, indium foils, or graphite sheets. The thermal management solution can be a conformal solution that accommodates differences in heights of the integrated circuit dies for which the thermal management solution provides cooling. For example, a thermal management solution can comprise a substantially planar cooling component with TIMs of varying thickness between the cooling component and the integrated circuit dies. In another example, the cooling component is non-planar, and the profile of the cooling component can vary with the thickness of the integrated circuit dies for which the cooling component provides cooling. In such embodiments, the TIM can be of substantially uniform thickness between the cooling component and the integrated circuit dies of varying thicknesses. Thermal management solutions can also include an integrated heat spreader.

The die 102, 104, 106, and 118, may be unpackaged integrated circuit die, and may alternatively be referred to as chips, chiplets, chip complexes, or chiplet complexes. The PIC die employ at least some optical communication, and the fiber array units (FAUs) may implement optical switching functionality. While the terms die, chip, and chiplet may be used interchangeably, the term chiplet is sometimes used to refer to an integrated circuit die that implements a subset of the functionality of a larger integrated circuit component. Although the illustration depicts the chiplets as having uniform dimensions, in practice, chiplet dimensions (lateral dimensions, as well as thickness) and shape can vary among chiplets; moreover, the chiplets may vary by type/functionality (e.g., compute, memory, I/O, power management (controlling the delivery of power and/or providing power to components)). Any integrated circuit die, chip, or chiplet can implement any portion of the functionality of any processor unit described or referenced herein. Furthermore, a multi-die assembly 100 can have any shape, such as a substantially square shape, substantially rectangular shape, or substantially circular shape.

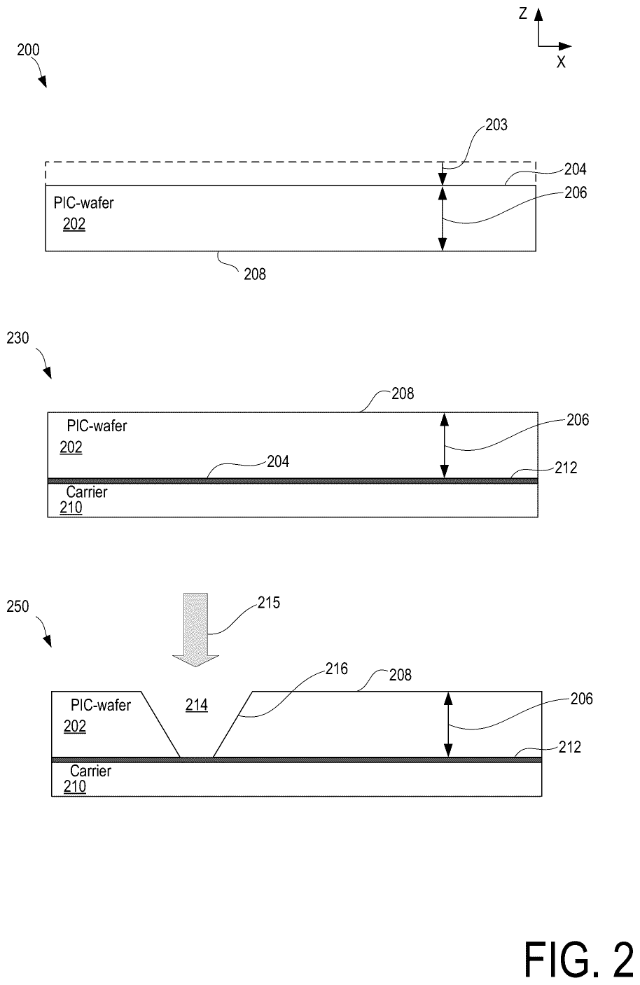

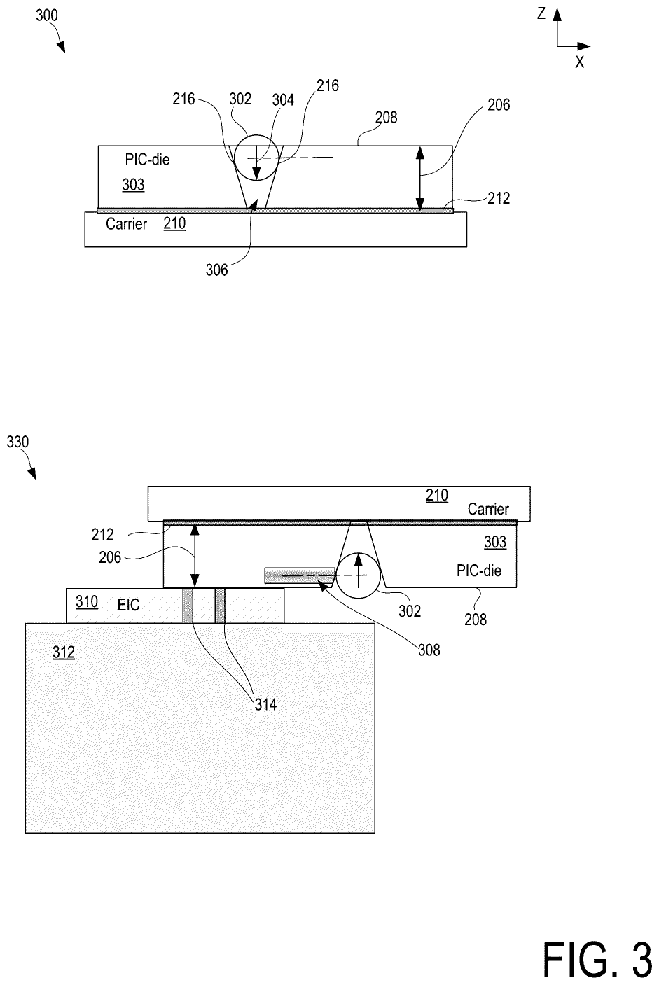

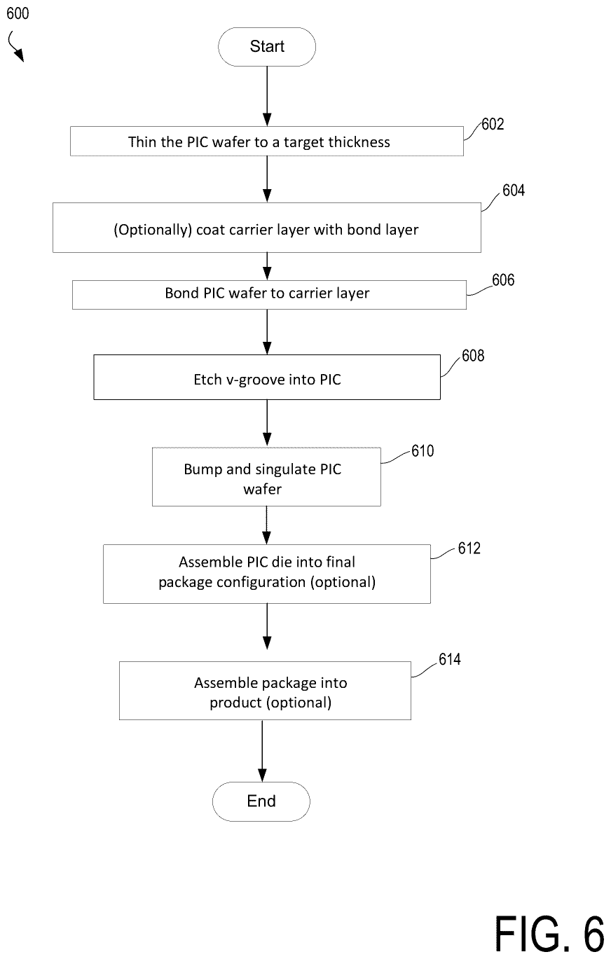

The dashed line 120 narrows the focus to an area of the substrate 112 that may implement an architecture for v-groove fiber attach for a PIC, as described herein. FIGS. 2-5 provide various exemplary embodiments and stages of development/manufacture of the architecture for v-groove fiber attach for a PIC. FIG. 6 provides an exemplary process flow 600 for creating embodiments described herein.

With reference to FIG. 2, embodiment 200 represents the PIC wafer 202 being thinned (a dashed rectangle and arrow 203 depict a removed layer of bulk silicon) to a target thickness 206 (at 602). In some embodiments, the target thickness is about 65 microns. In other embodiments, the target thickness may be more than 65 microns. The lower surface of the PIC in the figures represents an active surface 208 of the PIC, which extends upward therefrom into the thickness of the PIC wafer/die, to about 10 microns total thickness. The active surface 208 comprises optical circuity and/or optical routing, this is where the light travel in the PIC occurs. The active surface 208 and the upper surface 204 (also referred to as non-active surface 204) are both substantially planar.

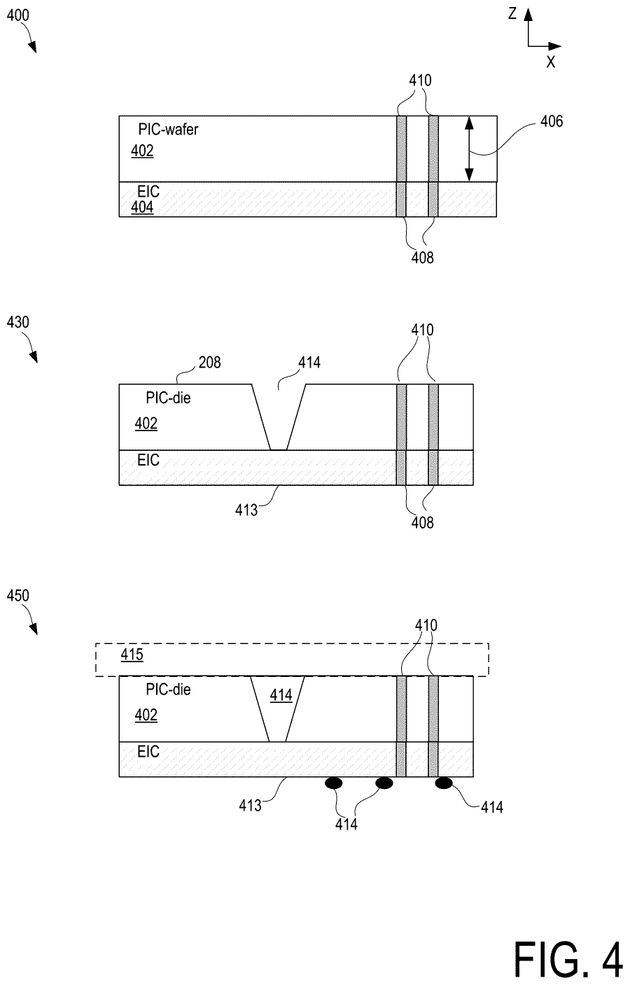

As shown in embodiment 230, in various embodiments, a carrier layer 210 is employed. The carrier layer may be a substrate layer on the second surface of the PIC. The carrier layer 210 is substantially planar and may comprise glass. As used herein, “glass” can be an alkali-free alkaline earth boro-aluminosicilate glass, such as a glass comprising aluminum, oxygen, boron, silicon, and an alkaline-earth metal (e.g., beryllium, magnesium, calcium, strontium, barium, radium, such as a glass comprising SiO₂, Al₂O₃, B₂O₃, and MgO), or a photosensitive glass (photomachineable or photostructurable glass). In some embodiments, a photosensitive glass can be a glass that belongs to the lithium-silicate family of glass (e.g., a glass comprising lithium, silicon, and oxygen) comprising metallic particles, such as gold, silver, or other suitable metallic particles. In alternate embodiments, the carrier layer may be implemented as an electronic integrated circuit (EIC 404), as shown in FIG. 4 embodiment 400, and described further below.

At 604, the carrier layer 210 may optionally have a bonding layer 212 overlaid on it. The bonding layer 212 also has a substantially planar surface, and may be an oxide surface passivation, such as a silicon oxide (SiOx, 0<x<2), a silicon nitride, a silicon carbon nitride, or any suitable equivalent that can bond the surfaces of the PIC wafer 202 and carrier layer 210 using a fusion bond process.

At 606 the non-active surface 204 of the PIC wafer 202 is bonded to the carrier layer 210, as shown in embodiment 230. In embodiments that implement the bonding layer 212, the lower surface 208 is bonded via the bonding layer 212 to the carrier layer 210 (or, to the substrate layer 212 on the second surface of the PIC), as illustrated in FIG. 2. Said differently, the PIC wafer 202 is located on the carrier layer 210 in an embodiment. In another embodiment, the PIC wafer 202 is located adjacent to a first surface of the bonding layer 212 and a second surface of the bonding layer 212 is adjacent to the carrier layer 210. Said differently, the bonding layer 212 is in between the PIC wafer 202 and the carrier layer 210.

At 608, as indicated by arrow 215 in embodiment 250, the v-grooves 214 are etched into the PIC wafer 202. The v-grooves 214 extend into the active surface 204 of the PIC wafer 202 to the depth of the PIC wafer 202. The v-grooves 214 have tapered or sloped walls 216, as created by the wet etch process. In various embodiments, the walls 216 are sloped at about 45 degrees to about 60 degrees, as measured from a planar surface such as the upper surface of the carrier layer 210.

Other approaches etch a v-groove into the PIC wafer alone (i.e., without the etch stop material being present), and the removal of the associated volume in three-dimensions from the PIC wafer alone can make the PIC wafer become fragile and susceptible to stress when so etched.

In contrast, in provided embodiments, the PIC wafer is thinner and the upper surface of the carrier layer 210 (or, when present, the bonding layer 212 on the carrier layer 210) acts as an etch stop. Although in provided embodiments the v-groove 214 still extends the thickness of the PIC wafer 202, this approach prevents the v-groove 214 from fully etching to a pointed trough/bottom. Said differently, v-grooves 214 have a depth equal to the thickness (of the PIC) and a floor that comprises the carrier layer. A scanning electron microscope (SEM) image of embodiments of the provided v-groove 214 would reveal a trapezoidal shape in a cross-sectional view, as shown in embodiment 250, wherein the v-groove 214 has a substantially flat floor comprising the material of carrier layer 210 (or the material of the bonding layer 212). Accordingly, provided embodiments advantageously result in improved PIC wafer 202 and PIC die strength and associated reliability and cost effectiveness.

At 606, alternate embodiments 400 may employ an electronic component wafer in the place of the carrier layer 210 and bond the PIC wafer 202 and subsequent PIC 402 die, directly on an upper surface 412 of an EIC 404 die. If the PIC 402 die are to have any TSVs, all required TSVs 410 are placed in the PIC wafer 202 comprising a plurality of PIC 402 die prior to the bonding at 606. After the bonding at 606, the TSVs 408 in the EIC 404 align with the TSVs 410 in the PIC 402 die. In various embodiments, TSVs 408 and TSVs 410 may be substantially filled with copper and/or tungsten.

As shown in exemplary embodiment 430, in embodiments that bond the PIC 402 to the EIC 404 at 606, the upper surface 412 of the EIC 404 acts as the etch stop in the wet etch process that creates the v-groove 414 at 608.

Note that in the various embodiments of the architecture, the flat bottom of the v-groove comprises a different layer or material than the material of the PIC wafer.

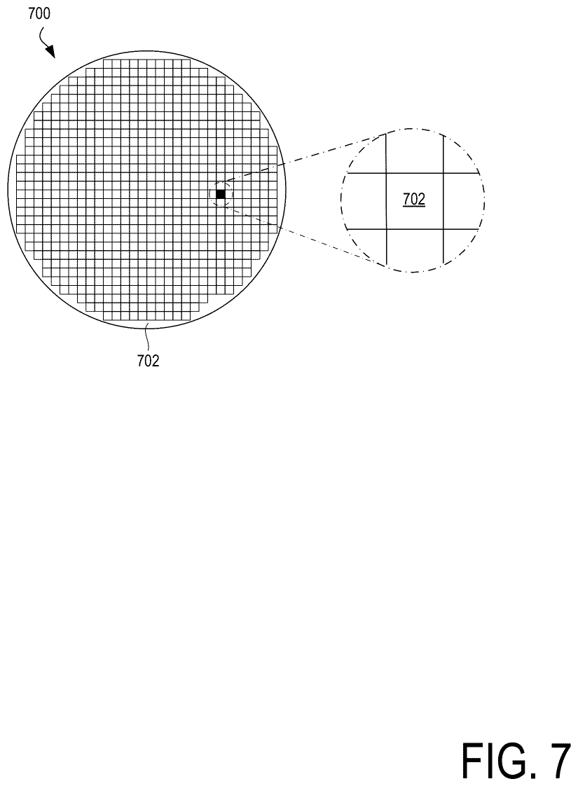

At 610, the PIC wafer 202 may be “bumped and singulated.” Bumping the PIC die may include adding solder balls as is conventionally done. Singulating the PIC die on the PIC wafer 202 includes cutting or otherwise separating the individual PIC die making up a PIC wafer 202. See FIG. 7 and associated text for more discussion about Singulating a wafer.

In embodiments that bond the PIC 402 die directly to an EIC 404, a carrier 415 may be removably attached to the active surface 204 of the PIC wafer 202 to provide stability for the duration of the bumping process at 610 (illustrated in exemplary embodiment 450). Solder bumps 418 may then be attached on the lower surface 413 of the EIC 404. The removably attached carrier 415 is removed prior placing optical fibers in the v-grooves 414.

At 612, a PIC die with the architecture for v-groove fiber attach for a PIC may be assembled into a final package configuration. Embodiment 300 illustrates a PIC 303 die singulated, and further details how the one or more optical fibers 302 are placed such that individual optical fibers 302 lie in respective one or more v-grooves 214 at 612.

Optical fiber 302 has radius 304. Notably, dimensions of the v-groove 214 are configured such that the optical fiber 302 touches opposing walls 216 of the v-groove 214 but does not touch the floor of the v-groove (as indicated by the gap 306 between the optical fiber 302 and the floor, in this manner, the “trough” created by the v-groove 214 supports the optical fiber 302 the same way that a fully V-shaped v-groove would). Alternately, it may be said that the optical fibers 302 in an application are selected such that their diameters are sufficient to ensure that the optical fibers 302 touch opposing walls but create a gap above the floor/carrier layer. Note that radius 304 of the optical fiber 302 is smaller than the target thickness 206. Said differently, the target thickness 206 (and depth of the v-groove 214) is a little more than the radius 304. In an example embodiment, the optical fibers have a diameter of 125 microns (+/−about 0.7 microns) and the target thickness is about 75 microns. In another example embodiment, the diameter of the optical fibers is in a range of about 70 to 80 microns, and the target thickness would be about 45 to 65 microns.

As part of the assembling of the singulated PIC die into a package assembly or final package configuration 330 at 612, the PIC may be flipped upside down as illustrated in final package configuration 330. An electronic component (EIC 310 die) is attached to a substrate 312 in the exemplary package configuration 330. For simplicity, most conductive traces and routing are omitted from the exemplary package configuration 330, but one with skill in the art will appreciate that the substrate 312 has conductive routing therein, and the EIC 310 has conductive routing therein, generally in the form of one or more redistribution layers sandwiched in dielectric layers. The EIC 310 may have one or more TSVs 314 that route signals and/or power and ground from a bottom side attached to the substrate 312 to the EIC 310 and beyond, to a top side of the EIC 310 from which the PIC 303 die may be attached. Surface optical fibers are arranged on the active surface of the PIC 303 die, as generally indicated with optical fiber 308 (in conjunction with optical fiber 302).

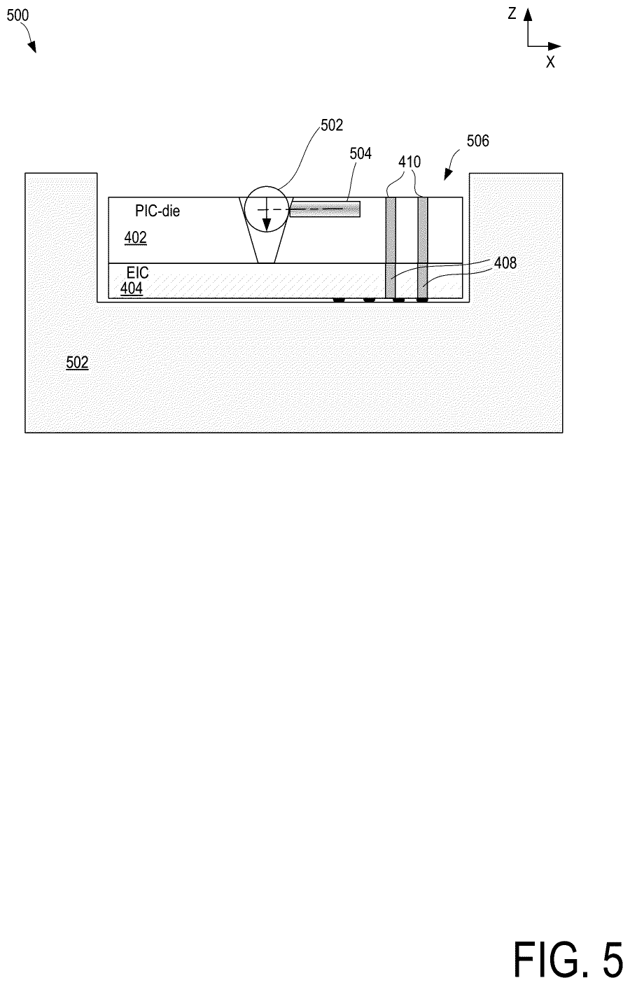

With reference to FIG. 5, in package assembly or final package configuration embodiments in which the PIC 402 die is adjacent to an EIC 404, the active surface does not have to be flipped upside down as it was in final package configuration 330. The exemplary embodiment 500 depicts the PIC 402-EIC 404 component placed in a cavity in substrate 508. Said differently, the PIC 402-EIC 404 component may be described as embedded in the substrate 508. Surface optical fibers are arranged on the active surface 506 of the PIC 402-EIC 404 component, as generally indicated with optical fiber 504 (in conjunction with optical fiber 502). In both embodiment 330 and embodiment 500, the EIC is in operable communication with the PIC and with the substrate.

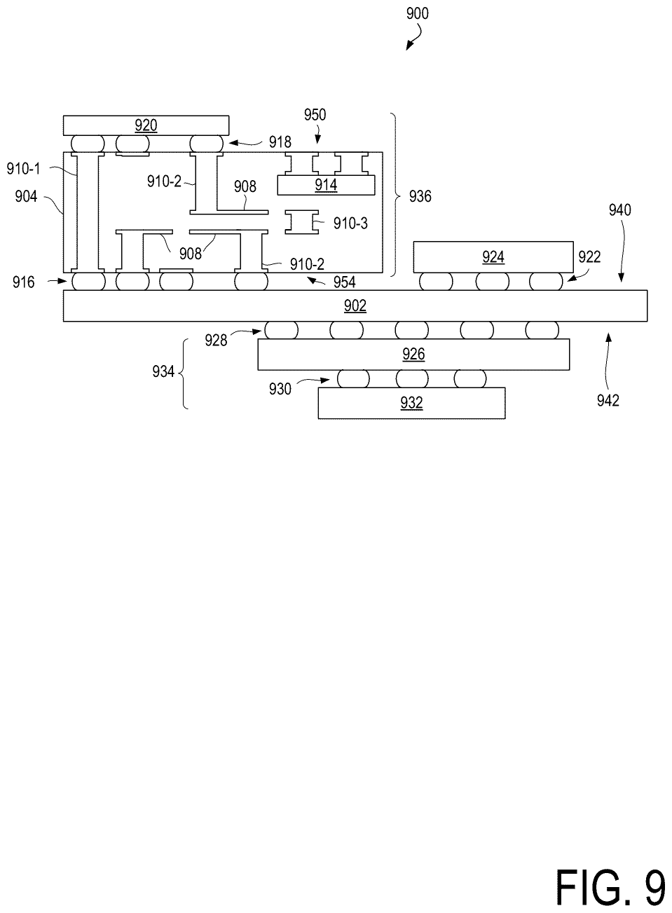

Another configuration that may include the PIC 303 die, or the PIC 402-EIC 404 component is the microelectronic assembly 900 in which any of the integrated circuit components, e.g., integrated circuit component 920, may be the EIC. FIG. 9 is described in more detail below.

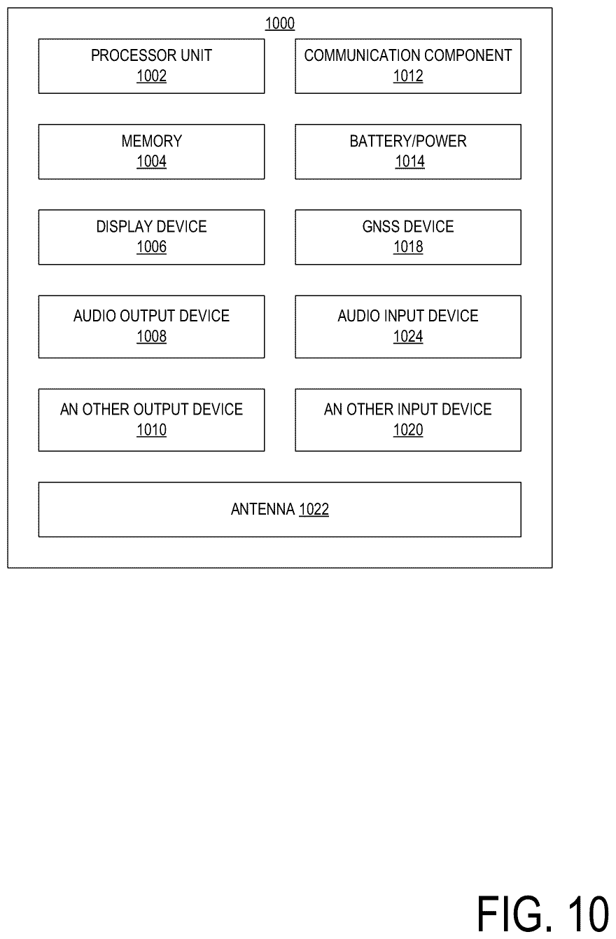

At 614, a package with a PIC die that implements the architecture for v-groove fiber attach for a PIC may be assembled into a device or product, such as electrical device 1000, FIG. 10. FIG. 10 is described in more detail below.

Thus, the architecture and method for v-groove fiber attach for a PIC has been described. To summarize, unique features of this invention that may be seen in a SEM image include (1) a v-groove in the PIC die, the v-groove characterized by tapered walls and a substantially flat bottom, and having a trapezoidal cross-sectional area, (2) the flat bottom of the v-groove comprising a different material (the carrier layer) than the material of the PIC wafer, and (3) a PIC wafer thickness that is less than about 100 microns. The following description and associated figures provide more detail for components referenced hereinabove.

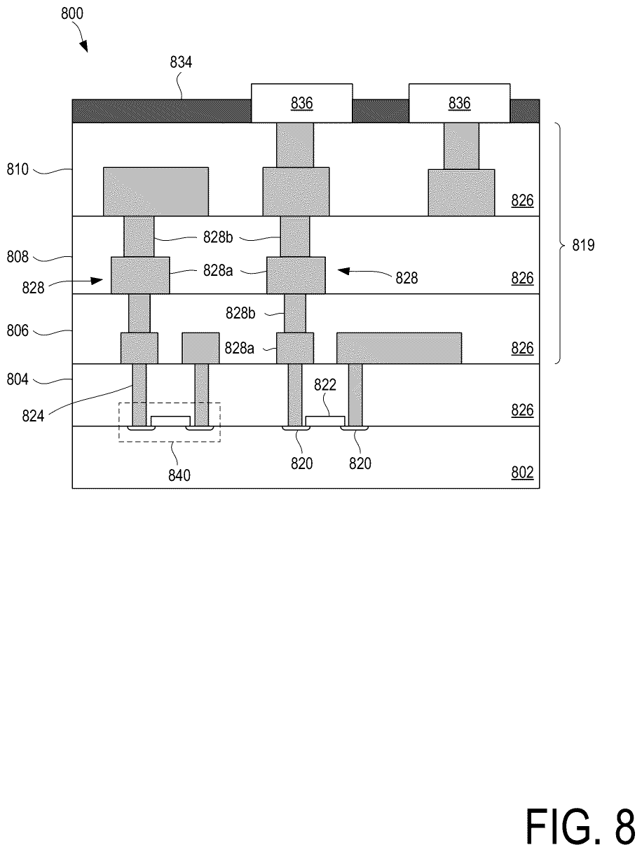

FIG. 7 is a top view of a wafer 700 and dies 702 that may be included in any of the embodiments disclosed herein. The wafer 700 may be composed of semiconductor material and may include one or more dies 702 formed on a surface of the wafer 700. After the fabrication of the integrated circuit components on the wafer 700 is complete, the wafer 700 may undergo a singulation process in which the dies 702 are separated from one another to provide discrete “chips” or destined for a packaged integrated circuit component. The individual dies 702, comprising an integrated circuit component, may include one or more transistors (e.g., some of the transistors 840 of FIG. 8, discussed below), supporting circuitry to route electrical signals to the transistors, passive components (e.g., signal traces, resistors, capacitors, or inductors), and/or any other integrated circuit components. In some embodiments, the wafer 700 or the die 702 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Additionally, multiple devices may be combined on a single die 702. For example, a memory array formed by multiple memory devices may be formed on a same die 702 as a processor unit (e.g., the processor unit 1002 of FIG. 10) or other logic that is configured to store information in the memory devices or execute instructions stored in the memory array. In some embodiments, a die 702 may be attached to a wafer 700 that includes other die, and the wafer 700 is subsequently singulated, this manufacturing procedure is referred to as a die-to-wafer assembly technique.

FIG. 8 is a cross-sectional side view of an integrated circuit 800 that may be included in any of the embodiments disclosed herein. One or more of the integrated circuits 800 may be included in one or more dies 702 (FIG. 7). The integrated circuit 800 may be formed on a die substrate 802 (e.g., the wafer 700 of FIG. 7) and may be included in a die (e.g., the die 702 of FIG. 7).

The die substrate 802 may be a semiconductor substrate composed of semiconductor material systems including, for example, n-type or p-type materials systems (or a combination of both). The die substrate 802 may include, for example, a crystalline substrate formed using a bulk silicon or a silicon-on-insulator (SOI) substructure. In some embodiments, the die substrate 802 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 802. Although a few examples of materials from which the die substrate 802 may be formed are described here, any material that may serve as a foundation for an integrated circuit 800 may be used. The die substrate 802 may be part of a singulated die (e.g., the dies 702 of FIG. 7) or a wafer (e.g., the wafer 700 of FIG. 7).

The integrated circuit 800 may include one or more device layers 804 disposed on the die substrate 802. The device layer 804 may include features of one or more transistors 840 (e.g., metal oxide semiconductor field-effect transistors (MOSFETs)) formed on the die substrate 802. The transistors 840 may include, for example, one or more source and/or drain (S/D) regions 820, a gate 822 to control current flow between the S/D regions 820, and one or more S/D contacts 824 to route electrical signals to/from the S/D regions 820.

The gate 822 may be formed of at least two layers, a gate dielectric and a gate electrode. The gate dielectric may include one layer or a stack of layers. The one or more layers may include silicon oxide, silicon dioxide, silicon carbide, and/or a high-k dielectric material. The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be conducted on the gate dielectric to improve its quality when a high-k material is used.

The gate electrode may be formed on the gate dielectric and may include at least one p-type work function metal or n-type work function metal, depending on whether the transistor 840 is to be a p-type metal oxide semiconductor (PMOS) or an n-type metal oxide semiconductor (NMOS) transistor. In some implementations, the gate electrode may comprise a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 840 along the source-channel-drain direction, the gate electrode may comprise a U-shaped structure that includes a bottom portion substantially parallel to the surface of the die substrate 802 and two sidewall portions that are substantially perpendicular to the top surface of the die substrate 802. In other embodiments, at least one of the metal layers that form the gate electrode may simply be a planar layer that is substantially parallel to the top surface of the die substrate 802 and does not include sidewall portions substantially perpendicular to the top surface of the die substrate 802. In other embodiments, the gate electrode may comprise a combination of U-shaped structures and planar, non-U-shaped structures. For example, the gate electrode may comprise one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and include deposition and etching process steps. In some embodiments, a plurality of spacer pairs may be used; for instance, two pairs, three pairs, or four pairs of sidewall spacers may be formed on opposing sides of the gate stack.

The S/D regions 820 may be formed within the die substrate 802 adjacent to the gate 822 of individual transistors 840. The S/D regions 820 may be formed using an implantation/diffusion process or an etching/deposition process, for example. In the former process, dopants such as boron, aluminum, antimony, phosphorous, or arsenic may be ion-implanted into the die substrate 802 to form the S/D regions 820. An annealing process that activates the dopants and causes them to diffuse farther into the die substrate 802 may follow the ion-implantation process. In the latter process, the die substrate 802 may first be etched to form recesses at the locations of the S/D regions 820. An epitaxial deposition process may then be conducted to fill the recesses with material that is used to fabricate the S/D regions 820. In some implementations, the S/D regions 820 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 820 may be formed using one or more alternate semiconductor materials such as germanium or a group III-V material or alloy. In further embodiments, one or more layers of metal and/or metal alloys may be used to form the S/D regions 820.

Electrical signals, such as power and/or input/output (I/O) signals, may be routed to and/or from the devices (e.g., transistors 840) of the device layer 804 through one or more interconnect layers disposed on the device layer 804 (illustrated in FIG. 8 as interconnect layers 806-810). For example, electrically conductive features of the device layer 804 (e.g., the gate 822 and the S/D contacts 824) may be electrically coupled with the interconnect structures 828 of the interconnect layers 806-810. The one or more interconnect layers 806-810 may form a metallization stack (also referred to as an “ILD stack”) 819 of the integrated circuit 800.

The interconnect structures 828 may be arranged within the interconnect layers 806-810 to route electrical signals according to a wide variety of designs; in particular, the arrangement is not limited to the particular configuration of interconnect structures 828 depicted in FIG. 8. Although a particular number of interconnect layers 806-810 is depicted in FIG. 8, embodiments of the present disclosure include integrated circuits having more or fewer interconnect layers than depicted.

In some embodiments, the interconnect structures 828 may include lines 828a and/or vias 828b filled with an electrically conductive material such as a metal. The lines 828a may be arranged to route electrical signals in a direction of a plane that is substantially parallel with a surface of the die substrate 802 upon which the device layer 804 is formed. For example, the lines 828a may route electrical signals in a direction in and out of the page and/or in a direction across the page. The vias 828b may be arranged to route electrical signals in a direction of a plane that is substantially perpendicular to the surface of the die substrate 802 upon which the device layer 804 is formed. In some embodiments, the vias 828b may electrically couple lines 828a of different interconnect layers 806-810 together.

The interconnect layers 806-810 may include a dielectric material 826 disposed between the interconnect structures 828, as shown in FIG. 8. In some embodiments, dielectric material 826 disposed between the interconnect structures 828 in different ones of the interconnect layers 806-810 may have different compositions; in other embodiments, the composition of the dielectric material 826 between different interconnect layers 806-810 may be the same. The device layer 804 may include a dielectric material 826 disposed between the transistors 840 and a bottom layer of the metallization stack as well. The dielectric material 826 included in the device layer 804 may have a different composition than the dielectric material 826 included in the interconnect layers 806-810; in other embodiments, the composition of the dielectric material 826 in the device layer 804 may be the same as a dielectric material 826 included in any one of the interconnect layers 806-810.

A first interconnect layer 806 (referred to as Metal 1 or “M1”) may be formed directly on the device layer 804. In some embodiments, the first interconnect layer 806 may include lines 828a and/or vias 828b, as shown. The lines 828a of the first interconnect layer 806 may be coupled with contacts (e.g., the S/D contacts 824) of the device layer 804. The vias 828b of the first interconnect layer 806 may be coupled with the lines 828a of a second interconnect layer 808.

The second interconnect layer 808 (referred to as Metal 2 or “M2”) may be formed directly on the first interconnect layer 806. In some embodiments, the second interconnect layer 808 may include via 828b to couple the lines 828 of the second interconnect layer 808 with the lines 828a of a third interconnect layer 810. Although the lines 828a and the vias 828b are structurally delineated with a line within individual interconnect layers for the sake of clarity, the lines 828a and the vias 828b may be structurally and/or materially contiguous (e.g., simultaneously filled during a dual-damascene process) in some embodiments.

The third interconnect layer 810 (referred to as Metal 3 or “M3”) (and additional interconnect layers, as desired) may be formed in succession on the second interconnect layer 808 according to similar techniques and configurations described in connection with the second interconnect layer 808 or the first interconnect layer 806. In some embodiments, the interconnect layers that are “higher up” in the metallization stack 819 in the integrated circuit 800 (i.e., farther away from the device layer 804) may be thicker that the interconnect layers that are lower in the metallization stack 819, with lines 828a and vias 828b in the higher interconnect layers being thicker than those in the lower interconnect layers.

The integrated circuit 800 may include a solder resist material 834 (e.g., polyimide or similar material) and one or more conductive contacts 836 formed on the interconnect layers 806-810. In FIG. 8, the conductive contacts 836 are illustrated as taking the form of bond pads. The conductive contacts 836 may be electrically coupled with the interconnect structures 828 and configured to route the electrical signals of the transistor(s) 840 to external devices. For example, solder bonds may be formed on the one or more conductive contacts 836 to mechanically and/or electrically couple an integrated circuit die including the integrated circuit 800 with another component (e.g., a printed circuit board). The integrated circuit 800 may include additional or alternate structures to route the electrical signals from the interconnect layers 806-810; for example, the conductive contacts 836 may include other analogous features (e.g., posts) that route the electrical signals to external components.

In some embodiments in which the integrated circuit 800 is a double-sided die, the integrated circuit 800 may include another metallization stack (not shown) on the opposite side of the device layer(s) 804. This metallization stack may include multiple interconnect layers as discussed above with reference to the interconnect layers 806-810, to provide electrically conductive paths (e.g., including conductive lines and vias) between the device layer(s) 804 and additional conductive contacts (not shown) on the opposite side of the integrated circuit 800 from the conductive contacts 836.

In other embodiments in which the integrated circuit 800 is a double-sided die, the integrated circuit 800 may include one or more through-silicon vias (TSVs) through the die substrate 802; these TSVs may make contact with the device layer(s) 804, and may provide electrically conductive paths between the device layer(s) 804 and additional conductive contacts (not shown) on the opposite side of the integrated circuit 800 from the conductive contacts 836. In some embodiments, TSVs extending through the substrate can be used for routing power and ground signals from conductive contacts on the opposite side of the integrated circuit 800 from the conductive contacts 836 to the transistors 840 and any other components integrated into the die 800, and the metallization stack 819 can be used to route I/O signals from the conductive contacts 836 to transistors 840 and any other components integrated into the die 800.

Multiple integrated circuits 800 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

FIG. 9 is a cross-sectional side view of a microelectronic assembly 900 that may include any of the embodiments disclosed herein. The microelectronic assembly 900 includes multiple integrated circuit components disposed on a circuit board 902 (which may be a motherboard, system board, mainboard, etc.). The microelectronic assembly 900 may include components disposed on a first face 940 of the circuit board 902 and an opposing second face 942 of the circuit board 902; generally, components may be disposed on one or both faces 940 and 942.

In some embodiments, the circuit board 902 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 902. In other embodiments, the circuit board 902 may be a non-PCB substrate. The microelectronic assembly 900 illustrated in FIG. 9 includes a package-on-interposer structure 936 coupled to the first face 940 of the circuit board 902 by coupling components 916. The coupling components 916 may electrically and mechanically couple the package-on-interposer structure 936 to the circuit board 902, and may include solder balls (as shown in FIG. 9), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 936 may include an integrated circuit component 920 coupled to an interposer 904 by coupling components 918. The coupling components 918 may take any suitable form for the application, such as the forms discussed above with reference to the coupling components 916. Although a single integrated circuit component 920 is shown in FIG. 9, multiple integrated circuit components may be coupled to the interposer 904; indeed, additional interposers may be coupled to the interposer 904. The interposer 904 may provide an intervening substrate used to bridge the circuit board 902 and the integrated circuit component 920.

The integrated circuit component 920 may be a packaged or unpackaged integrated circuit component that includes one or more integrated circuit dies (e.g., the die 702 of FIG. 7, the integrated circuit 800 of FIG. 8) and/or one or more other suitable components.

The unpackaged integrated circuit component 920 comprises solder bumps attached to contacts on the die. The solder bumps allow the die to be directly attached to the interposer 904. In embodiments where the integrated circuit component 920 comprises multiple integrated circuit die, the die can be of the same type (a homogeneous multi-die integrated circuit component) or of two or more different types (a heterogeneous multi-die integrated circuit component). In addition to comprising one or more processor units, the integrated circuit component 920 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate, or combinations thereof. A packaged multi-die integrated circuit component can be referred to as a multi-chip package (MCP) or multi-chip module (MCM).

The interposer 904 may spread connections to a wider pitch or reroute a connection to a different connection. For example, the interposer 904 may couple the integrated circuit component 920 to a set of ball grid array (BGA) conductive contacts of the coupling components 916 for coupling to the circuit board 902. In the embodiment illustrated in FIG. 9, the integrated circuit component 920 and the circuit board 902 are attached to opposing sides of the interposer 904; in other embodiments, the integrated circuit component 920 and the circuit board 902 may be attached to a same side of the interposer 904. In some embodiments, three or more components may be interconnected by way of the interposer 904.

In some embodiments, the interposer 904 may be formed as a PCB, including multiple metal layers separated from one another by layers of dielectric material and interconnected by electrically conductive vias. In some embodiments, the interposer 904 may be formed of an epoxy resin, a fiberglass-reinforced epoxy resin, an epoxy resin with inorganic fillers, a ceramic material, or a polymer material such as polyimide. In some embodiments, the interposer 904 may be formed of alternate rigid or flexible materials that may include the same materials described above for use in a semiconductor substrate, such as silicon, germanium, and other group III-V and group IV materials. The interposer 904 may include metal interconnects 908 and vias 910, including but not limited to through hole vias 910-1 (that extend from a first face 950 of the interposer 904 to a second face 954 of the interposer 904), blind vias 910-2 (that extend from the first or second faces 950 or 954 of the interposer 904 to an internal metal layer), and buried vias 910-3 (that connect internal metal layers).

In some embodiments, the interposer 904 can comprise a silicon interposer. Through-silicon vias (TSV) extending through the silicon interposer can connect connections on a first face of a silicon interposer to an opposing second face of the silicon interposer. In some embodiments, an interposer 904 comprising a silicon interposer can further comprise one or more routing layers to route connections on a first face of the interposer 904 to an opposing second face of the interposer 904.

The interposer 904 may further include embedded devices 914, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 904. The package-on-interposer structure 936 may take the form of any of the package-on-interposer structures known in the art.

The integrated circuit assembly 900 may include an integrated circuit component 924 coupled to the first face 940 of the circuit board 902 by coupling components 922. The coupling components 922 may take the form of any of the embodiments discussed above with reference to the coupling components 916, and the integrated circuit component 924 may take the form of any of the embodiments discussed above with reference to the integrated circuit component 920.

The integrated circuit assembly 900 illustrated in FIG. 9 includes a package-on-package structure 934 coupled to the second face 942 of the circuit board 902 by coupling components 928. The package-on-package structure 934 may include an integrated circuit component 926 and an integrated circuit component 932 coupled together by coupling components 930 such that the integrated circuit component 926 is disposed between the circuit board 902 and the integrated circuit component 932. The coupling components 928 and 930 may take the form of any of the embodiments of the coupling components 916 discussed above, and the integrated circuit components 926 and 932 may take the form of any of the embodiments of the integrated circuit component 920 discussed above. The package-on-package structure 934 may be configured in accordance with any of the package-on-package structures known in the art.

FIG. 10 is a block diagram of an example electrical device 1000 that may include one or more of the embodiments disclosed herein. For example, any suitable ones of the components of the electrical device 1000 may include one or more of the PICs in embodiment 300, PICs in embodiment 430, package assemblies, microelectronic assemblies 900, integrated circuit components 920, integrated circuits 800, integrated circuit dies 702, or structures disclosed herein. A number of components are illustrated in FIG. 10 as included in the electrical device 1000, but any one or more of these components may be omitted or duplicated, as suitable for the application. In some embodiments, some or all the components included in the electrical device 1000 may be attached to one or more motherboards, mainboards, printed circuit boards, or system boards. In some embodiments, one or more of these components are fabricated onto a single system-on-a-chip (SoC) die. In various embodiments, the electrical device 3000 is enclosed by, or integrated with, a housing.

Additionally, in various embodiments, the electrical device 1000 may not include one or more of the components illustrated in FIG. 10, but the electrical device 1000 may include interface circuitry for coupling to the one or more components. For example, the electrical device 1000 may not include a display device 1006, but may include display device interface circuitry (e.g., a connector and driver circuitry) to which a display device 1006 may be coupled. In another set of examples, the electrical device 1000 may not include an audio input device 1024 or an audio output device 1008, but may include audio input or output device interface circuitry (e.g., connectors and supporting circuitry) to which an audio input device 1024 or audio output device 1008 may be coupled.

The electrical device 1000 may include one or more processor units 1002 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1002 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller crypto processors (specialized processors that execute cryptographic algorithms within hardware), server processors, controllers, or any other suitable type of processor units. As such, the processor unit can be referred to as an XPU (or xPU).

The electrical device 1000 may include a memory 1004, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1004 may include memory that is located on the same integrated circuit die as the processor unit 1002. This memory may be used as cache memory (e.g., Level 1 (L1), Level 2 (L2), Level 3 (L3), Level 4 (L4), Last Level Cache (LLC)) and may include embedded dynamic random-access memory (eDRAM) or spin transfer torque magnetic random-access memory (STT-MRAM).

In some embodiments, the electrical device 1000 can comprise one or more processor units 1002 that are heterogeneous or asymmetric to another processor unit 1002 in the electrical device 1000. There can be a variety of differences between the processor units 1002 in a system in terms of a spectrum of metrics of merit including architectural, microarchitectural, thermal, power consumption characteristics, and the like. These differences can effectively manifest themselves as asymmetry and heterogeneity among the processor units 1002 in the electrical device 1000.

In some embodiments, the electrical device 1000 may include a communication component 1012 (e.g., one or more communication components). For example, the communication component 1012 can manage wireless communications for the transfer of data to and from the electrical device 1000. The term “wireless” and its derivatives may be used to describe circuits, devices, systems, methods, techniques, communications channels, etc., that may communicate data using modulated electromagnetic radiation through a nonsolid medium. The term “wireless” does not imply that the associated devices do not contain any wires, although in some embodiments they might not.

The communication component 1012 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra-mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1012 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1012 may operate in accordance with other wireless protocols in other embodiments. The electrical device 1000 may include an antenna 1022 to facilitate wireless communications and/or to receive other wireless communications (such as AM or FM radio transmissions).

In some embodiments, the communication component 1012 may manage wired communications, such as electrical, optical, or any other suitable communication protocols (e.g., IEEE 802.3 Ethernet standards). As noted above, the communication component 1012 may include multiple communication components. For instance, a first communication component 1012 may be dedicated to shorter-range wireless communications such as Wi-Fi or Bluetooth, and a second communication component 1012 may be dedicated to longer-range wireless communications such as global positioning system (GPS), EDGE, GPRS, CDMA, WiMAX, LTE, EV-DO, or others. In some embodiments, a first communication component 1012 may be dedicated to wireless communications, and a second communication component 1012 may be dedicated to wired communications.

The electrical device 1000 may include power supply such as a battery/power circuitry 1014. The battery/power circuitry 1014 may include one or more energy storage devices (e.g., batteries or capacitors) and/or circuitry for coupling components of the electrical device 1000 to an energy source separate from the electrical device 1000 (e.g., AC line power).

The electrical device 1000 may include a display device 1006 (or corresponding interface circuitry, as discussed above). The display device 1006 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1000 may include an audio output device 1008 (or corresponding interface circuitry, as discussed above). The audio output device 1008 may include any embedded or wired or wirelessly connected external device that generates an audible indicator, such speakers, headsets, or earbuds.

The electrical device 1000 may include an audio input device 1024 (or corresponding interface circuitry, as discussed above). The audio input device 1024 may include any embedded or wired or wirelessly connected device that generates a signal representative of a sound, such as microphones, microphone arrays, or digital instruments (e.g., instruments having a musical instrument digital interface (MIDI) output). The electrical device 1000 may include a Global Navigation Satellite System (GNSS) device 1018 (or corresponding interface circuitry, as discussed above), such as a Global Positioning System (GPS) device. The GNSS device 1018 may be in communication with a satellite-based system and may determine a geolocation of the electrical device 1000 based on information received from one or more GNSS satellites, as known in the art.

The electrical device 1000 may include another output device 1010 (or corresponding interface circuitry, as discussed above). Examples of the other output device 1010 may include an audio codec, a video codec, a printer, a wired or wireless transmitter for providing information to other devices, or an additional storage device.

The electrical device 1000 may include another input device 1020 (or corresponding interface circuitry, as discussed above). Examples of the other input device 1020 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1000 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra-mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1000 may be any other electronic device that processes data. In some embodiments, the electrical device 1000 may comprise multiple discrete physical components. Given the range of devices that the electrical device 1000 can be manifested as in various embodiments, in some embodiments, the electrical device 1000 can be referred to as a computing device or a computing system.

Thus, embodiments of an improved via structure for use with the embedded component have been provided. The provided embodiments advantageously enable the use of finer pitch architectures and high-density input/output (I/O) designs in multi-chip packaging.

While at least one embodiment has been presented in the foregoing detailed description, it should be appreciated that a vast number of variations exist. It should also be appreciated that the disclosed embodiments are only examples, and are not intended to limit the scope, applicability, or configuration of the disclosure in any way. Rather, the foregoing detailed description will provide those skilled in the art with a convenient road map for implementing the disclosed embodiment embodiments. Various changes can be made in the function and arrangement of elements without departing from the scope of the disclosure as set forth in the appended claims and the legal equivalents thereof.

As used herein, phrases such as “an embodiment,” “various embodiments,” “some embodiments,” and the like, indicate that some embodiments may have some, all, or none of the features described for other embodiments. “First,” “second,” “third,” and the like describe a common object and indicate different instances of like objects being referred to; unless specifically stated, they do not imply a given sequence, either temporally or spatially, in ranking, or any other manner. In accordance with patent application parlance, “connected” indicates elements that are in direct physical or electrical contact with each other and “coupled” indicates elements that co-operate or interact with each other, coupled elements may or may not be in direct physical or electrical contact. Furthermore, the terms “comprising,” “including,” “having,” and the like, are utilized synonymously to denote non-exclusive inclusions.

As used in this application and the claims, a list of items joined by the term “at least one of” or the term “one or more of” can mean any combination of the listed terms. For example, the phrase “at least one of A, B or C” can mean A; B; C; A and B; A and C; B and C; or A, B, and C. Likewise, the phrase “one or more of A, B and C” can mean A; B; C; A and B; A and C; B and C; or A, B, and C.

As used in this application and the claims, the phrase “individual of” or “respective of” following by a list of items recited or stated as having a trait, feature, etc. means that all the items in the list possess the stated or recited trait, feature, etc. For example, the phrase “individual of A, B, or C, comprise a sidewall” or “respective of A, B, or C, comprise a sidewall” means that A comprises a sidewall, B comprises sidewall, and C comprises a sidewall.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following examples pertain to additional embodiments of technologies disclosed herein.

### EXAMPLES

Example 1 is an apparatus, comprising: a photonic integrated circuit (PIC) characterized by a thickness of less than about 100 microns; one or more v-grooves extending into the PIC from a first surface of the PIC; a carrier layer (i.e., a substrate layer) on a second surface of the PIC; and the one or more v-grooves having a depth equal to the thickness and a floor that comprises the carrier layer.

Example 2 includes the subject matter of Example 1, further comprising: an optical fiber located in a v-groove of the one or more v-grooves, the optical fiber having a radius sufficient for the optical fiber to touch opposing walls of the v-groove of the one or more v-grooves; and a gap between the floor and the optical fiber.

Example 3 includes the subject matter of any one of Examples 1-2, further comprising a bonding layer between the PIC and the carrier layer.

Example 4 includes the subject matter of Example 3, wherein the bonding layer comprises one or more of a silicon oxide, a silicon nitride, and a silicon carbon nitride.

Example 5 includes the subject matter of Example 3, wherein the bonding layer comprises SiOx, wherein x is 0, 1, or 2.

Example 6 includes the subject matter of any one of Examples 1-3, wherein the carrier layer comprises silicon and oxygen.

Example 7 includes the subject matter of any one of Examples 1-3, wherein the carrier layer comprises silicon, oxygen, and aluminum, boron, or an alkaline-earth metal.

Example 8 includes the subject matter of any one of Examples 1-7, wherein a carrier layer thickness is in a range of about 20 micron to about 1 millimeter.

Example 9 includes the subject matter of any one of Examples 1-8, wherein the first surface of the PIC comprises optical routing.

Example 10 includes the subject matter of any one of Examples 1-9, further comprising: a substrate; an electronic integrated circuit (EIC) attached on a first side of the EIC to the substrate; and wherein the first surface of the PIC is attached to a second side of the EIC.

Example 11 is a system comprising the subject matter of Example 10, further comprising a housing enclosing the apparatus.

Example 12 includes the subject matter of any one of Examples 1-9, wherein the carrier layer comprises an electronic integrated component (EIC).

Example 13 includes the subject matter of Example 12, further comprising: a substrate;

and wherein the EIC is located between, and in operable communication with, the substrate and the PIC.

Example 14 is a system comprising the subject matter of Example 13, further comprising a housing enclosing the apparatus.

Example 15 is a package assembly, comprising: a photonic integrated circuit (PIC) comprising: a thickness of less than about 100 microns; one or more v-grooves extending into the PIC from a first surface of the PIC and having a depth equal to the thickness; a carrier layer bonded on a second surface of the PIC; and the one or more v-grooves having a floor that comprises the carrier layer; a substrate attached to the PIC; and an electronic integrated component attached to the substrate.

Example 16 includes the subject matter of Example 15, wherein the carrier layer comprises a glass layer or an electronic integrated circuit (EIC).

Example 17 includes the subject matter of Example 15, further comprising a printed circuit board (PCB), the PCB attached to the substrate.

Example 18 includes the subject matter of Example 15, further comprising a second integrated circuit component attached to the substrate.

Example 19 is a system comprising the subject matter of Example 15, and further comprising a housing enclosing the package assembly.

Example 20 is a device comprising the subject matter of Example 15, and further comprising one or more of a power supply, a communications system, and a memory component.

Example 21 is a method, comprising: thinning a photonic integrated circuit (PIC) to a thickness of less than about 100 microns; bonding a carrier layer to a non-active surface of the PIC; and creating one or more v-grooves in an active surface of the PIC, the one or more v-grooves having a depth equal to the thickness and a floor that comprises the carrier layer.

Example 22 includes the subject matter of Example 21, further comprising: placing an optical fiber in one v-groove of the one or more v-grooves, the optical fiber having a radius sufficient for the optical fiber to touch opposing walls of the one v-groove and create a gap between the floor and the optical fiber.

Example 23 includes the subject matter of any one of Examples 21 or 22, further comprising: attaching an electronic integrated circuit (EIC) on a first side of the EIC to a substrate; and attaching the active surface of the PIC to a second side of the EIC.

Example 24 includes the subject matter of any one of Examples 21-23, wherein the carrier layer comprises glass.

Example 25 includes the subject matter of any one of Examples 21-23, wherein the carrier layer comprises an electronic integrated circuit.

What is claimed is:

1. An apparatus, comprising:
a photonic integrated circuit (PIC) characterized by a thickness of less than about 100 microns;
one or more v-grooves extending into the PIC from a first surface of the PIC;
a substrate layer on a second surface of the PIC; and
the one or more v-grooves having a depth equal to the thickness and a floor that comprises the substrate layer.

2. The apparatus of claim 1, further comprising:
an optical fiber located in a v-groove of the one or more v-grooves, the optical fiber having a radius sufficient for the optical fiber to touch opposing walls of the v-groove of the one or more v-grooves; and
a gap between the floor and the optical fiber.

3. The apparatus of claim 1, further comprising a bonding layer between the PIC and the substrate layer.

4. The apparatus of claim 3, wherein the bonding layer comprises one or more of a silicon oxide, a silicon nitride, and a silicon carbon nitride.

5. The apparatus of claim 1, wherein the substrate layer comprises silicon and oxygen.

6. The apparatus of claim 1, wherein the first surface of the PIC comprises optical routing.

7. The apparatus of claim 1, further comprising:
a substrate; and
an electronic integrated circuit (EIC) attached on a first side of the EIC to the substrate; and
wherein the first surface of the PIC is attached to a second side of the EIC.

8. A system comprising the apparatus of claim 7, further comprising a housing enclosing the apparatus.

9. The apparatus of claim 1, wherein the substrate layer comprises an electronic integrated component (EIC).

10. The apparatus of claim 9, further comprising:
a substrate; and
wherein the EIC is located between, and in operable communication with, the substrate and the PIC.

11. A system comprising the apparatus of claim 10, further comprising a housing enclosing the apparatus.

12. A package assembly, comprising:
a photonic integrated circuit (PIC) comprising:
a thickness of less than about 100 microns;
one or more v-grooves extending into the PIC from a first surface of the PIC and having a depth equal to the thickness;
a substrate layer bonded on a second surface of the PIC; and
the one or more v-grooves having a floor that comprises the substrate layer;
a substrate attached to the PIC; and
an electronic integrated component attached to the substrate.

13. The package assembly of claim 12, wherein the substrate layer comprises glass or an electronic integrated circuit (EIC).

14. The package assembly of claim 12, further comprising a printed circuit board (PCB), the PCB attached to the substrate.

15. A device comprising the package assembly of claim 14, and further comprising one or more of a power supply, a communications system, and a memory component.

16. A method, comprising:
thinning a photonic integrated circuit (PIC) to a thickness of less than about 100 microns;
bonding a substrate layer to a non-active surface of the PIC; and
creating one or more v-grooves in an active surface of the PIC, the one or more v-grooves having a depth equal to the thickness and a floor that comprises the substrate layer.

17. The method of claim 16, wherein the substrate layer comprises glass.

18. The method of claim 16, wherein the substrate layer comprises an electronic integrated circuit.

19. The method of claim 16, further comprising:
placing an optical fiber in one v-groove of the one or more v-grooves, the optical fiber having a radius sufficient for the optical fiber to touch opposing walls of the one v-groove and create a gap between the floor and the optical fiber.

20. The method of claim 16, further comprising:
attaching the active surface of the PIC to first side of an electronic integrated circuit (EIC); and
attaching a second side of the EIC to a substrate.
